(19) United States
(12) Patent Application Publication
(10) Pub. No.: US 2016/0221748 A1
(43) Pub. Date: Aug. 4, 2016

(54) BAKERY PRODUCTS IN TUBES AND METHOD OF THEIR PRODUCTION

(71) Applicant: Sergey Vyacheslavovich ARZAMASTSEV, St.Petersburg (RU)

(72) Inventor: Sergey Vyacheslavovich ARZAMASTSEV, St.Petersburg (RU)

(21) Appl. No.: 15/082,311

(22) Filed: Mar. 28, 2016

Related U.S. Application Data
(63) Continuation-in-part of application No. 14/514,810, filed on Oct. 15, 2014.

(30) Foreign Application Priority Data
Jun. 26, 2014 (RU) 2014125936

(51) Int. Cl. B65D 85/72; B65B 7/02; B65D 35/44; B65D 35/04; B65D 35/38; A21D 13/00; B65B 25/16

(52) U.S. Cl. CPC B65D 85/72; A21D 13/0067; B65B 7/02; B65B 25/16; B65D 35/04; B65D 35/38; B65D 35/44

(57) ABSTRACT

Disclosed herein are food-dispensing tubes comprising one or more layers of varying food products within each tube. The layers may be horizontal, vertical, or a combination. The food products remain separate within the tube without the need for barriers but are excreted in a combinatory form. Most food products comprise a paste-like mass which is made up of both larger and smaller particles of food. The larger particles provide a sense of fresh product and a savory mouthfeel. The smaller particles ensure that the space within the tube is packed full and no air pockets exist. Food products within a single tube may include but are not limited to bread, meat, fish, vegetables, cheese, sauces, condiments, seasonings, and starches. The food within the tube is ready to eat and convenient to ingest on the go or during an activity. Methods for producing the tubes are also disclosed.

### CROSS-REFERENCE TO RELATED APPLICATIONS

This patent application is a Continuation-in-Part of U.S. patent application Ser. No. 14/514,810, filed Oct. 15, 2014, which claims priority to, and incorporates fully by reference, Russian Patent Application Ser. No. RU2014125936, filed Jun. 26, 2014.

### FIELD OF THE INVENTION

This invention relates to the nutrition industry, and particularly to tubes used for packing, storing, transporting, selling, and ingesting a food product.

### BACKGROUND OF THE INVENTION

The nutrition of participants involved in the ground model experiment imitating flight to Mars is known prior art (see Patent of the Russian Federation No. 2426456, A23L1148, priority date 31 Aug. 2010). This process provides for 3 stages. The 1st stage from the 1st to the 250th day, imitating flight to Mars, includes 5-course meal by semi-finished products of ready-made meals with the energy value of a breakfast 19-21%, a dinner of 29-31%, a supper of 29-31% and two intermediate food intakes with the energy value of each 9-11% of the daily energy content of the day food products. The 2nd stage from the 251st to the 280th day, imitating flight in an orbit of Mars and landing to its surface, is represented by two types of meals, one of which is provided for a group imitating landing and work on the surface of Mars, and includes 4-course meals with the energy value of a breakfast of 19-21%, the 2nd breakfast of 14-16%, a dinner of 34-36% and a supper of 29-31% of the daily energy content of the day food products. With that for this group the tinned, ready-made cold, first dishes reconstituted by hot water and hot drinks are used. The 3rd stage from the 281st to the 520th day, imitating flight to Earth, provides 4-course meal in the form of ready-made meals of sublimation dehydration with the energy value of a breakfast of 24-26%, a dinner of 34-36%, a supper of 24-26% and intermediate food intakes of 14-16% of the daily energy content of the day food products. The 2nd stage provides the meal similar to those at the 3rd stage for the remaining people, imitating flight in the orbit of Mars.

The prior art noted above is intended to create the feeding method of the long-term autonomy, with the food ration of the set energy value that preserves the biological full-value and microbiological safety throughout the whole term of experiment in the absence of possibility to replenish the food stock, taking into account various stages of activity during the flight to Mars, with the use of the serially manufactured food products of the mass consumption. This analog has a restriction on possibility of its use on Earth.

There are two offered sets imitating food for astronauts, which are known: Kosmosnek and Kosmofood 2.0. (see the web-site http://space-food.ru/#products). These known products differ in structure. The Kosmosnek set consists of juice in a tube, separate bread, black or white (at option), and tea or coffee (at option) (see bigbuzzy.ru/catalog/x-line). Food imitation for astronauts is unacceptable for the human mass-market and is rather a curiosity.

The method of production of food products packaged in tubes is well-known (see the web-site, http://www.obobrali.ru/2012/04/eda-v-tyubikah-dlya-sovetskih-kosmonavtov/). However, even though this method can serve as the closest analog of the present invention, it is also unique, and intended for astronauts. The product in a tube does not contain bread, the tubes are one-layered, they “discharge” one type of food, are semi-finished. The best way possible to use such products is to make a sandwich.

U.S. Patent Publication No. 2008/0069485 A1 discloses a storing device which comprises a segment of a mesh material and an end for securing the mesh material. The secured mesh material is suitable for storing various items. The food product comprises a cooking apparatus and a foodstuff. The cooking apparatus comprises a steam permeable component for steam cooking a foodstuff. The cooking apparatus may further comprise a bag and/or a packet for steaming the foodstuff. While being able to store more than one type of food product, the disclosure in this prior art still requires the food product to be cooked. The present invention solves this problem by allowing for a vacuum/airtight seal for packaging and storing and also being ready to eat without requiring cooking. Furthermore, the present invention is an improvement upon this prior art because the food products inside the packaging are injected as separate and specific layers, which does not allow for full diffusion between products while being stored (a slight diffusion at the boundaries of layers may occur, which in fact enhances the combination of flavors without destroying the separation).

U.S. Pat. No. 6,287,612 discloses an article of manufacture that combines a squeezable food product and a packaging unit for storing and consuming of the food product. The squeezable food product includes a first food component forming a base component and a second food component forming a filling component. The first food component and the second food component form a combinable food product upon consumption having sensory and nutritive properties close to a solid metal. The packaging unit is a supple pouch having a main external squeezable body and at least one partition layer which divides the squeezable body into at least two separate cavities. The first and second food components are separately stored in different cavities. On extrusion and recombination, the two food components are perceivable as two different components. This prior art discloses two or more cavities within a container but lacks the ability to withstand long storage time based on the composition of the container. Furthermore, the prior art requires a partition to form separate cavities and lacks any type of nozzle or opening which allows for uniform and controlled extrusion of the product located within each container. The present invention is an improvement over the prior art's required partitions and lack of utility. Additional improvement over the prior art will be evident from the description of the present invention below.

### SUMMARY OF THE INVENTION

The present invention is a food dispenser, comprising a squeezable tube, the tube comprising a top end with a narrowing outlet neck coupled to a nozzle, a cap for sealing the top end, and a sealed bottom end. One or more food products are packaged into the squeezable tube, wherein at least one of said food products comprises bread, and at least one of the food products comprises a paste-like mass. The food products form one or more layers within the tube, the food dispenser is air tight before opening, and the food products are ready to eat.

In some aspects, the layers are vertical layers. In some aspects, the tube also contains a barrier between each vertical layer, the bather forming individual chambers within the tube, and the barrier ending at the narrowing outlet neck.

In some aspects, two or more food products are packaged into the tube such that each of the two or more food products form alternating individual horizontal layers within the tube. In some aspects, the alternating individual horizontal layers are uniform. In some aspects, the alternating individual horizontal layers are non-uniform, such that no two combinatory excretions of food products caused by a squeezing of the tube are the same.

In some aspects, the food product comprising bread comprises particles up to 10 mm in diameter.

In some aspects, a first food product comprising a paste-like mass of bread forms a first vertical layer, and a second food product comprising a paste-like mass forms a second vertical layer, wherein a squeezing of said tube causes a combinatory excretion of the first and second food products through the nozzle.

In some aspects, a first food product comprising a paste-like mass of bread forms a first vertical layer, and a second food product comprising a homogenous fluid forms a second vertical layer, wherein a squeezing of the tube causes a combinatory excretion of the first and second food products through the nozzle. In some aspects, the first food product comprises bread particles up to 10 mm in diameter.

In some aspects, a first food product comprising a paste-like mass of bread forms a first vertical layer, a second food product comprising a homogenous fluid forms a second vertical layer, and a third food product comprising a paste-like mass forms a third vertical layer, wherein a squeezing of the tube causes a combinatory excretion of the first, second, and third food products through the nozzle. In some aspects, the third food product comprises protein. In some aspects, the first food product comprises bread particles up to 10 mm in diameter and the third food product comprises protein particles up to 10 mm in diameter.

In some aspects, the dispenser further comprises a removable membrane, the membrane sealing the nozzle prior to use.

A method of producing a food dispenser is also described herein. The method comprises the steps of: processing at least one food product to form a paste-like mass, where the paste-like mass comprises chewable food particles up to 10 mm in diameter, packaging the food product(s) into one or more layers within a squeezable tube, and sealing the squeezable tube at both ends.

In some aspects, the packaging step is performed by an injecting machine.

In some aspects, the injecting machine further comprises one or more barriers, the barriers facilitating a formation and a separation (i.e. less diffusion within the tube) of the layers of food product within the tube.

In some aspects, the one or more layers are vertical layers. In some aspects, the one or more layers are horizontal layers. In some aspects, the one or more layers are vertical layers and the vertical layers further consist of horizontal layers within them.

### BRIEF DESCRIPTION OF THE DRAWINGS

FIG. 1 shows an exemplary tube according to the present invention.

FIGS. 2-3 show cross-sectional view examples of how food product layers may be organized within a tube, especially, although not necessarily, when one or more barriers are used within the tube.

FIG. 4 shows a general side-view example of a tube without a cap according to the present invention.

FIG. 5 shows a side-view example of a tube with to cap, and an example of alternating individual horizontal layers of different food products within a single vertical layer.

FIG. 6A shows an example of employing an injecting tube comprising barriers to package different food products into three separate vertical layers through the open tail end of one tube. The injecting tube and barriers are removed from the squeezable tube before sealing of the bottom end; however, the vertical layers of food product remain separate without requiring barriers within the tube.

FIG. 6B shows a sealed version of a tube comprising three vertical layers of food product.

FIG. 7 shows a peripheral view of a tube with a cap and an open/unsealed tail (or bottom) end.

FIGS. 8A-8D show varying embodiments of the head of the tube according to the present invention examples of various combinations of a screw thread nozzle, flat nozzle, screw cap, locking cap, and flip cap are shown.

FIG. 9 shows how a nozzle may be further sealed with a removable membrane to preserve freshness.

FIGS. 10A-10B show the dimension ranges of the nozzle and tube according to the present invention. FIG. 10A shows a top view of a tube, while FIG. 10B shows a side view of the same tube.

### DETAILED DESCRIPTION OF THE PREFERRED EMBODIMENT

The present invention may comprise one or more food products having a paste-like state (“paste-like state,” or “paste-like condition”, or “paste-like mass,” as used interchangeably herein, is defined as comprising both larger and gradually smaller food particles, wherein no particle has a diameter larger than the nozzle of a tube). The food product injected into a tube must comprise a bread component, or bakery product (hereinafter, “bread” or “bread product”) and may further comprise one or more additional ingredients in varying proportions, as exemplified below. The term “bread” is used here for all variety of bakery products, including loafs, buns, rolls, pretzels, bagels, crackers, pita, challah, baguette, etc. Additional ingredients include but are not limited to cheese products, meat/fish products comprising different ingredients (e,g., pork, beef, chicken, fish, ham, sausage, venison, vegetables, and mixtures thereof), soup products, starch products, seasoning products, and condiment/sauce products.

The term “air-tight,” as used herein, is defined as no air entering or exiting the container. Furthermore, the term may include, but does not necessitate, the fact that absolutely no air pockets exist within a container, such as the tubes described herein. In some embodiments of the present invention, minor air pockets exist within the container, but the container is still referred to as “air-tight” because no transfer of air is possible from the inside to the outside of the container, and vice versa (prior to opening, and in some cases, after opening as well). In other embodiments of the present invention, no air pockets exist within the container and no air enters or exits the container (prior to opening, and in some cases, after opening as well).

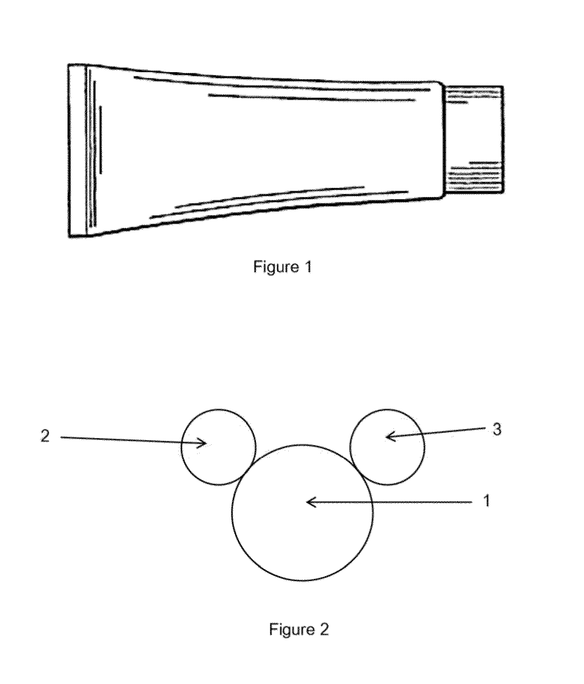

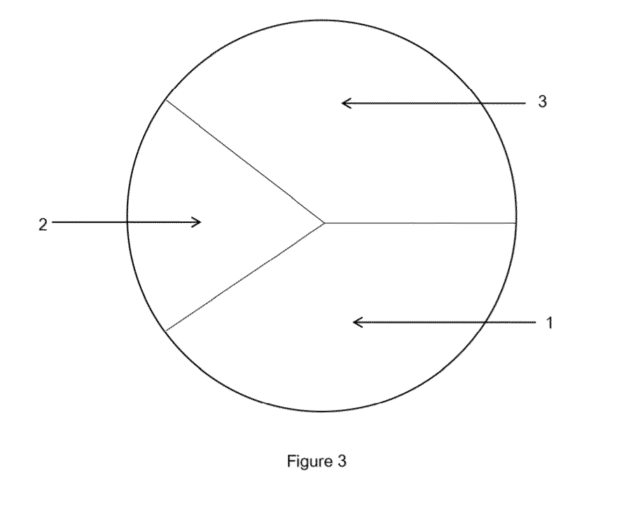

FIG. 1 shows an example embodiment of the present invention, comprising a food-dispensing and food-containing package comprising a tube of cylindrical form with a cap. The tube may contain one, two, or multiple layers of food product. FIG. 2 shows a tube embodiment (end, or cross-sectional, view) with three cylindrical layers 1, 2, 3. FIG. 3 shows another cross-sectional view of an embodiment of a tube implementation wherein the layers 1, 2, 3 are integrated within a single cylindrical tube body. Although not necessary, such embodiments as shown in FIGS. 2-3 are likely to occur with the employment of barriers, as described below. Different manners of organizing the layers are also possible (e.g., parallel layers, varying proportions, etc.). Also, different manners of organizing layers of different food products are possible (e.g., horizontal layers of varying food products on top of each other in a single vertical layer or in multiple vertical layers, or vertical layers without horizontal layers, etc.). The tube materials may comprise one or a combination of plastic, aluminum, and cardboard. Other known materials may also be used. The food product layers, in addition to the main products discussed herein, may also contain salt, juice, spices, seasonings, or any other cooking ingredient. The preferred embodiment of the present invention does not contain barriers (i.e. walls) within the tube, thus allowing for slight diffusion between layers of food product within the tube as well as non-uniform excretion, if desired. The paste-like state of the food products disclosed herein as defined and discussed hereinbelow) permits for the maintained separation of individual layers of food product without the need for any such barrier. The slight diffusion that does occur at the boundaries of the food products enhances the combination of flavors without destroying the separation (and thus maintaining freshness of individual food products). In other embodiments, and particularly those embodiments comprising more than one layer of food product, one or more barriers may be placed within a tube in order to create separate chambers and thus a pure separation of food products from each other (i.e. no diffusion until excretion). The barriers may be either solid (e.g., metal) or flexible (e.g., plastic), depending on the purpose and application of a particular tube product.

The present invention comprises one or more food products having a paste-like state (“paste-like state,” or “paste-like condition”, or “paste-like mass,” as used interchangeably herein, is defined as comprising both larger and gradually smaller food particles, wherein no particle has a diameter larger than the nozzle of a tube). The food product injected into a tube must comprise a bread component, or bakery product (hereinafter, “bread” or “bread product”) and may further comprise one or more additional ingredients in varying proportions, as exemplified below. Additional ingredients include but are not limited to cheese products, meat/fish products comprising different ingredients (e.g., pork, beef, chicken, fish, ham, sausage, venison, vegetables, and mixtures thereof), soup products, starch products, seasoning products, and condiment/sauce products.

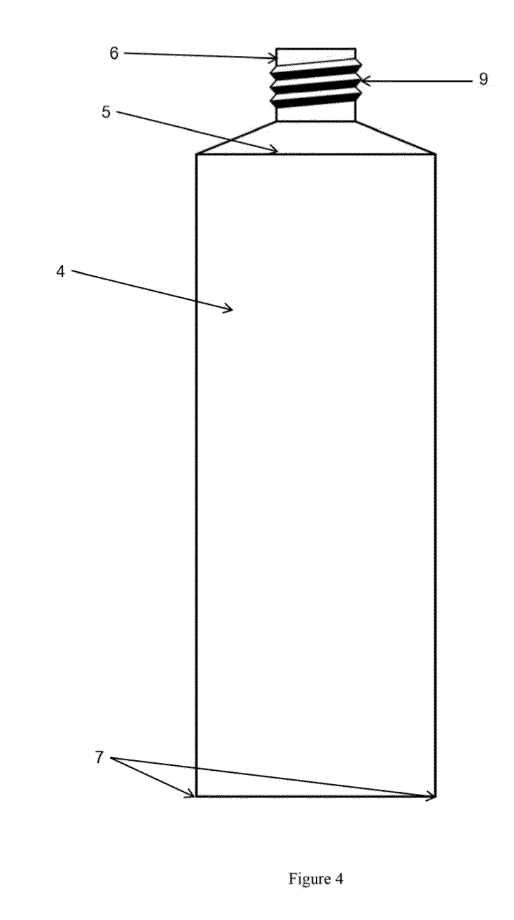

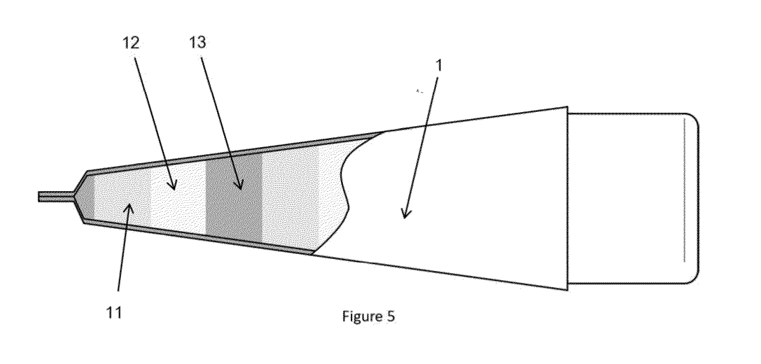

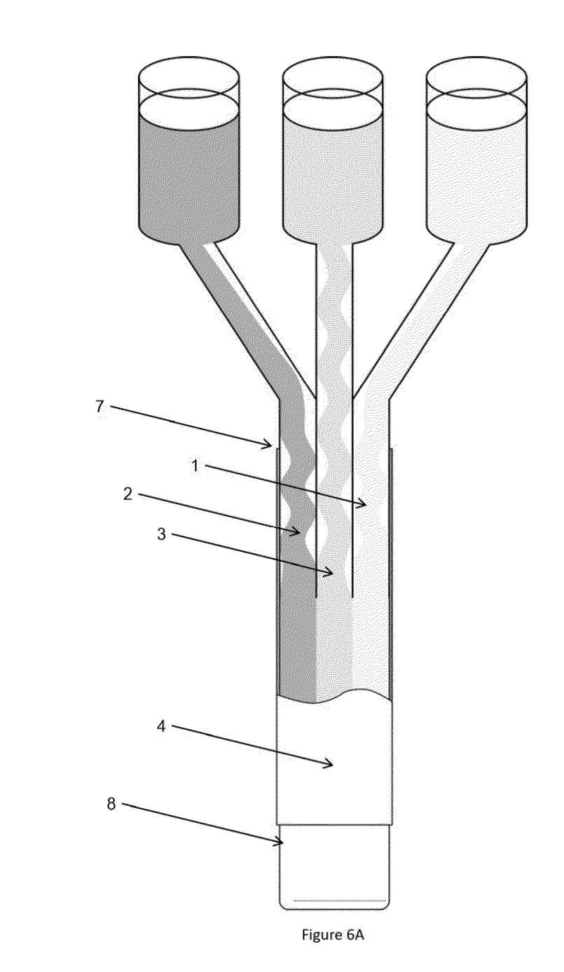

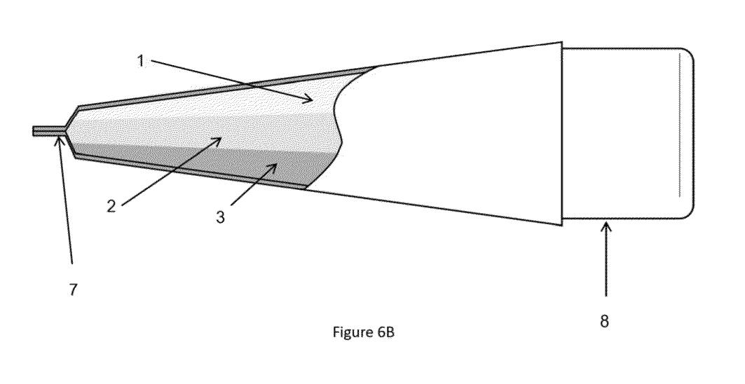

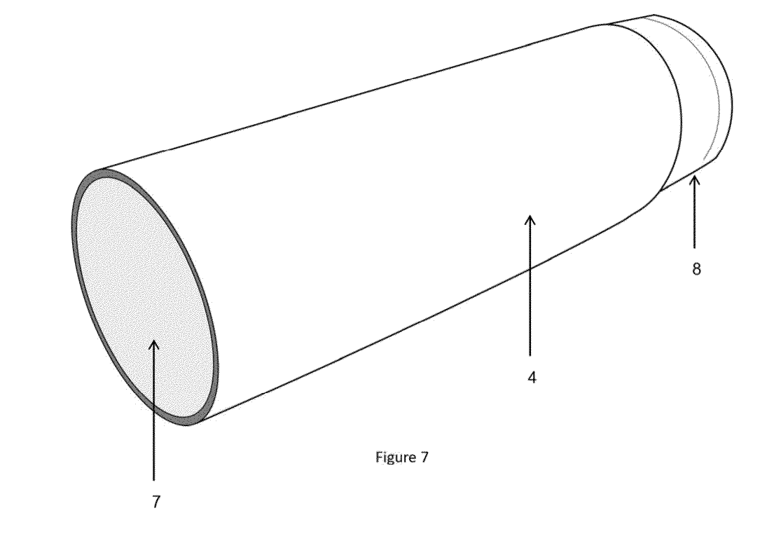

The food product(s) is packaged/injected into a tube 4 for other handheld dispensing container) having a narrowing outlet neck 5 and a nozzle 6 (see FIG. 4). The different food products mentioned above do not mix with each other within the tube to the point of a single homogenous substance. In other words, the different products are either injected into particular segments/layers 1, 2, 3 of the tube 4 (e.g., vertical individualized layers, as shown in FIGS. 6A, B) or are injected in a layered manner such that the layers form a pattern of alternating individual food products (either paste-like masses or homogenous fluids). Such patterns may be formed within a single layer or within multiple layers (e.g., horizontal layers 11, 12, 13 within a single vertical layer 1 are shown in FIG. 5). FIG. 6A shows how vertical layers of food product may be injected into a tube using an injecting machine. The injecting machine itself comprises barriers to allow for injection of varying food products in layers. When the tube is filled, the injecting machine is removed and the vertical layers of food products remain separated without the need for internal cavities. When the tube is ready for consumption and squeezed, further diffusion between layers occurs within the tube as well as at the point of the narrowing outlet neck 5. In the case of vertical layers, the composition exiting the nozzle 6 comprises a combination of all food products from each vertical layer. In the case of horizontal layers within one layer, each layer comprising a different food product is excreted individually to form a layered concoction providing a pattern of varying individual flavors. In the case of horizontal layers within multiple vertical layers (not shown in drawings), it is possible to combine the effects of each of the embodiments described above to increase the randomization of varying flavors and provide for a greater diffusion between food products within the tube and exiting the nozzle.

As stated previously, many, if not all, food products injected into the tube comprise particles creating a paste-like condition, wherein the diameter of particles/fragments is not larger than the diameter of the opening of the nozzle (alternatively, not larger than the diameter of the shortest portion of the outlet neck, which is equal to the diameter of the nozzle). The size of the nozzle is no larger than 30 mm in diameter. In some aspects, the one or more food products within a tube may entirely comprise a homogenous fluid without any paste-like state or substances. Such homogenous fluids, however, may still exist as separate layers within the tube, with only slight diffusion at the boundaries of layers, and with no diffusion at the boundaries if barriers are used.

The larger particles within the paste-like mass allow for the layers within a tube to remain separate without the need for an internal barrier because the larger particles are more difficult to displace within the tube. The smaller particles located between the larger particles are thus also harder to displace. This combination creates a food product capable of maintaining its structure (compare to, e.g., a runny liquid substance) and remaining separate within the tube. The fact that the food particles within the paste are comprised of both smaller and larger particles also allows the food products to be packaged into the tubes in an air-tight manner, wherein smaller particles fill in the space formed between larger particles. The composition of the paste-like mass further allows for the packaged tube to be airtight before opening and to remain airtight even after opening (with or without the use of a cap). Due to the dynamic between gradually increasing size of moldable particles of food (e.g., wet/soft bread, wet/soft protein, wet/soft vegetables) within each layer containing a paste-like mass, the food product is capable of filling in every air pocket therein. When the tube is squeezed, the food product is excreted without allowing any entrance of air into the tube. In addition, the fact that the particles are all individually smaller than the diameter of the nozzle allows for easy and uniform extrusion from the vacuum when the tube is squeezed.

The packaged product comprises both bread and varying additives which allow for processing of the bread such that the combination forms a paste-like mass containing large and small particles (i.e. particles with varying diameter sizes ranging from 0.1 mm to 10 mm, wherein the maximum size of particles depends on the size of the nozzle, or shortest portion of the outlet neck, and also potentially the number of layers within the tube). The bread product is injected into at least one portion of (i.e. as one layer of) the tube. Other layers of the tube, if present, comprise different food products processed with and without varying additives to create a paste-like mass with similarly sized large and small particles. Some layers of food product, such as cheese, sauces, and condiments, may be processed into either a homogenous fluid or a paste-like mass, depending on the proportion of the product to others and/or the desired diffusion rate within the tube.

The bread filling comprising the main food product pastes may be made from ingredients including but not limited to rye, wheat, corn, rice, whole grain, white bread, black bread, buckwheat, unleavened bread, crackers, dry bread, additives for viscosity, and combinations thereof. The bread is ground to a consistency such that varying sized particles of the bread product exist, both large and small. The large particles create a chewable consistency while the smaller particles fill in the space between larger particles to remove any air and form an overall paste-like substance that maintains its shape and structure within the tube. The bread may further be combined with products including but not limited to soy, water, milk, vegetable broth, and meat/fish.

The meat/fish filling (or vegetarian meat/product filling) comprising one of the food product pastes may be made using a variety of different methods for cooking (e.g., frying, boiling, baking, steaming, or combinations thereof) at temperatures ranging from 60 degrees Celsius to 350 degrees Celsius. The meat may come from one or more animals (e.g., including but not limited to beef, pork, chicken, fish, lamb, ham, game, and mixtures thereof) and may be combined with vegetables or other vegetarian compositions, as well as with additives for, e.g., viscosity. The meat/fish/vegetable composition is processed to a consistency such that varying sized particles of the composition exist, both large and small. The large particles create a chewable consistency while the smaller particles fill in the space between larger particles to remove any air, combining to form a paste-like substance that maintains its shape and structure within the tube.

The cheese filling comprising another one of the food product pastes may be made from one or more types of milk (e.g., whole, normalized, reduced fat, skim, dry, or combinations thereof). The cheese may further be made using bacterial starter cultures and/or rennet, with or without adding natural or synthetic dyes. The cheese filling may be further flavored naturally or artificially. The cheese filling may be made from hard cheese, soft cheese, processed cheese, or combinations thereof. The cheese filling may comprise ready-made cheese. The cheese may comprise a cheese product rather than pure cheese (e.g. fat free cheese product, protein-free cheese product, flavored cheese product, etc.). The cheese may similarly be processed to a consistency such that varying sized particles of the bread product exist, both large and small. The large particles create a chewable consistency while the smaller particles fill in the space between larger particles to remove any air, combining to form an overall paste-like substance that maintains its shape and structure. The cheese product may alternatively be processed such that no larger particles exist (in fact, until no particles exist at all), forming a homogenous fluid substance, rather than a paste-like mass, wherein the fluid substance is less capable of maintaining its structure and shape.

The sauce/condiment filling comprising another optional food product paste may be made using different sauces including but not limited to mayonnaise, ketchup, sour cream, mustard, relish, cranberry, and combinations thereof. Sauce/condiment fillings may be processed to form either a paste-like mass or a homogenous fluid mixture.

The method of production of the bread food product may comprise separately processing and injecting bread and cheese in two different layers within a tube. The bread and cheese may, e.g. be processed to form individual paste-like masses which are injected as varyingly sized layers of a tube depending on the desired or optimal proportions of bread to cheese, e.g., in proportions of 50-90 g of bread and 10-50 g of cheese, per 100 g of total product. The method of production may alternatively comprise separately processing and injecting bread and meat/fish/vegetables in two different layers of a tube. The bread and meat/fish/vegetables may be processed to form individual paste-like masses which are injected as different sized layers of a tube depending on the desired or optimal proportions of bread to meat/fish, e.g., in proportions of 50-90 g of bread and 10-50 g of meat/fish, per 100 g of total product. A third layer may be injected, thus allowing for injection of bread, meat/fish, and cheese in separate layers and at varying proportions, and so on. For example, proportions of 50-90 g of bread, 5-25 g of meat, fish or another type of spread, and 5-25 g of cheese, per 100 g of total product, may be used. Additional fillings may also be added, if necessary or desired, depending on a particular recipe, e.g., 0-20 g of ketchup, 0-20 g of mayonnaise, 0-20 g of mustard, and modifying the proportions of other ingredients to equal 100 g of total product.

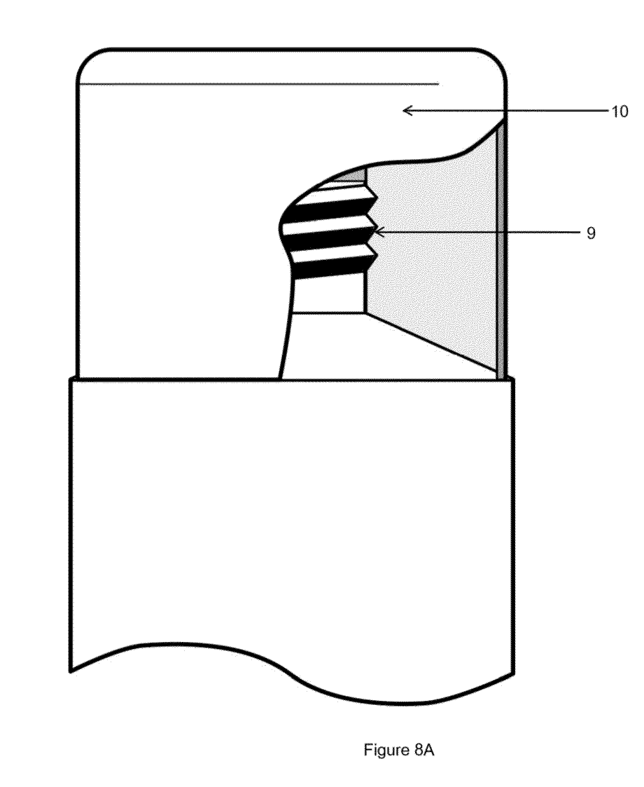

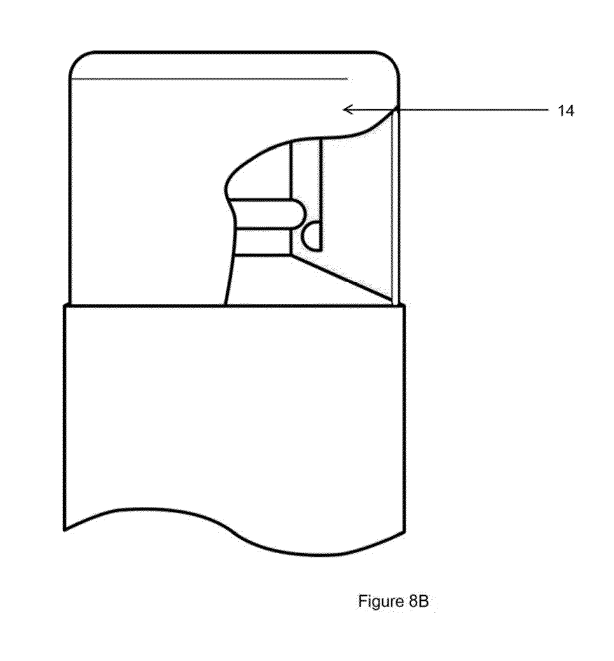

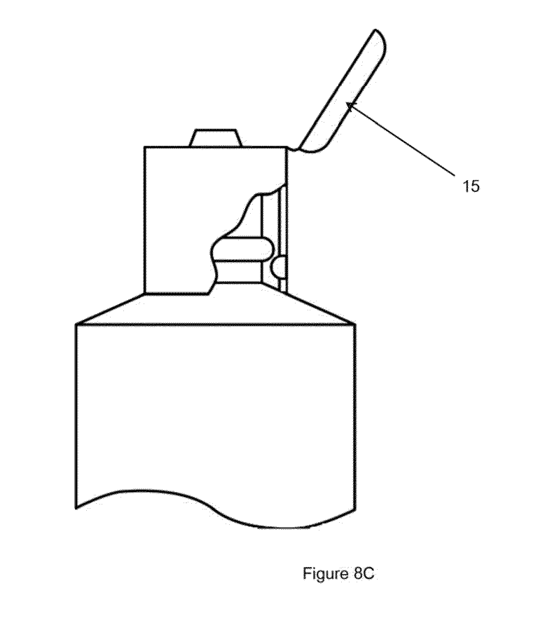

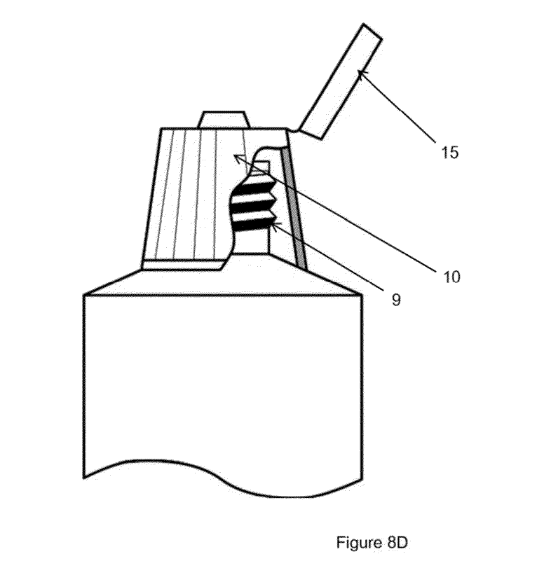

The method for packing, or injecting, the food product up to the step of sealing comprises the following steps and structure. The tube 4 comprises a compressible container or vessel having a cylindrical shape. The far end of the tube (hereinafter, the “tail” or “bottom end”) 7 is initially open in order to insert food product (see FIGS. 4, 6, 7). Injection may occur with or without the use of an injecting machine. The injecting machine may further comprise sections formed by barriers in order to assist the packaging of varying food products in a layered manner (see, e.g., FIG. 6A). The injecting machine is removed once the tube is filled to capacity and then the bottom end of the tube is sealed. The other end of the tube (hereinafter, the “head” or “top end”) 8 has a narrowing portion comprising the outlet neck 5 and nozzle 6 (see FIG. 4, 7). The nozzle may comprise a screw thread 9 on which a screw cap 10 is positioned (FIG. 8A). Alternatively, the neck may comprise a locking cap 14 (FIG. 8B) or a flip cap 15 (FIG. 8C) instead of a screw thread and screw cap, or a combination of a screw thread 9, screw cap 10, and flip cap 15 (FIG. 8D).

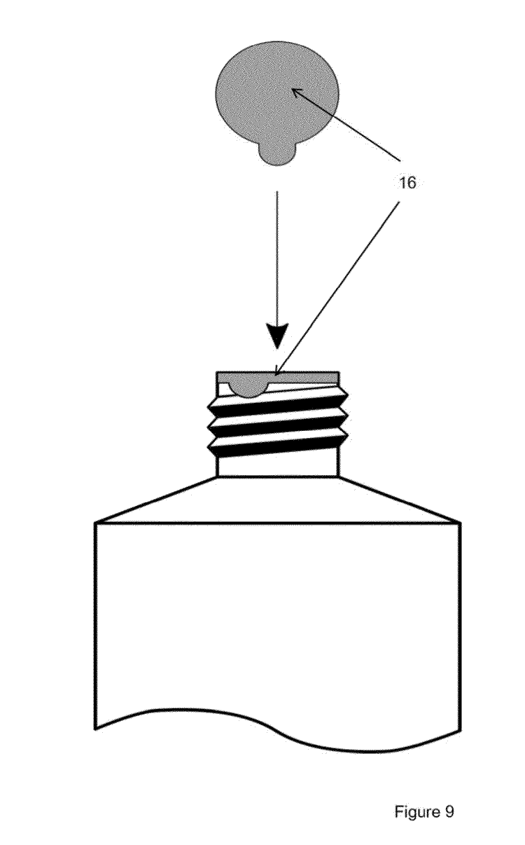

The nozzle may further be sealed when necessary with a removable or pierceable membrane 16 for an additional air-tight seal prior to consumption (FIG. 9).

The tube may have a volume ranging between about 50 ml and 300 ml.

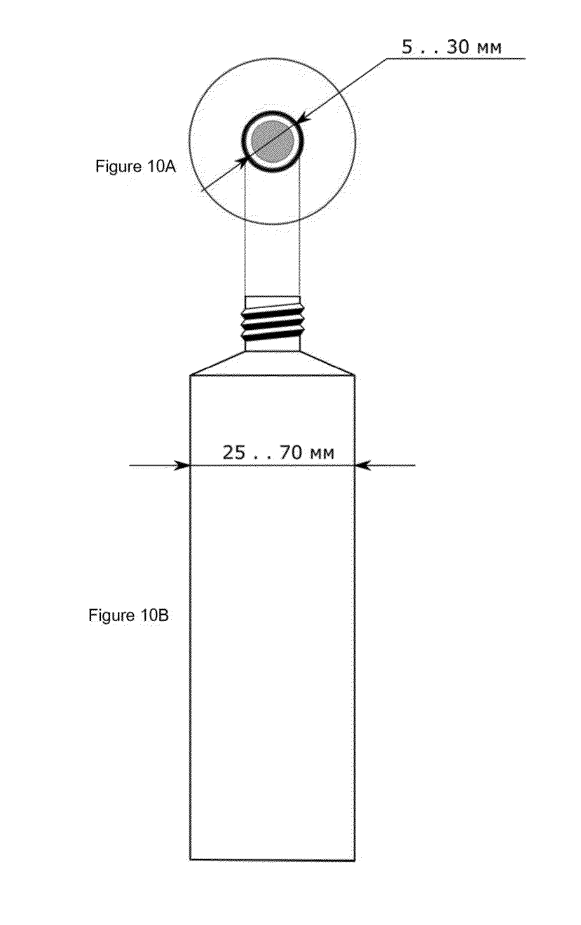

The tube may have a diameter ranging between about 25 mm and 70 mm (FIG. 10B).

The diameter of the nozzle opening, or of the shortest portion of the outlet neck of the tube, depending on the size of the tube, may have a diameter ranging between about 5 mm to about 30 mm (FIG. 10A).

After the food product is injected into the tube, the tail 7 is sealed, cut, and/or tightly twisted.

The method of processing and packaging the product comprises the following steps. The particular steps or order of steps may depend on the application and on the recipe. In one embodiment, the steps for processing and packaging are as follows. The ingredients comprising each food product paste are ground separately into a paste-like condition (i.e., a state where the particles comprising the paste are crumbs and/or lumps with a diameter value no greater than the diameter of the nozzle of the tube into which the particles are inserted). In some aspects, this value is less than 25 mm. In some aspects, this value is less than 20 mm. In some aspects, this value is less than 10 mm. And in some aspects, this value is less than 5 mm.

The food products are also separately subjected to pasteurization and/or sterilization using special equipment in an aseptic condition. The sterilized/pasteurized products are then placed into a sterile tube, using a sterilized filling and packaging machine. Once the tube is filled with a sufficient amount of food product(s) such that no air exists inside the tube (i.e. forming a vacuum by allowing for smaller particles to enter all spaces formed between larger particles such that no air pockets exist), a process for sealing the head and the tail of the tube is employed. It should be noted that completely sterile equipment is used throughout the process until the tube is sealed. Thus, the end product obtained is a pasteurized or sterilized food product in a hermetically sealed package.

In another embodiment, the steps for processing and packaging may be as follows. The food product(s) are injected into a clean tube. The tube is filled sufficiently such that no air exists within the tube (i.e., forming a vacuum) using equipment such as a filling and packaging machine. Once the product(s) is injected, the tail of the tube is sealed and the excess material above/below the sealing seam is trimmed. Then, the product in the tube is subjected, depending on the recipe, to pasteurization or sterilization using special equipment.

Both of the above methods for processing and packaging of the product allows for a maximum amount of nutrients to be saved (this value will vary based on the amount of thermal/heat exposure). The product, after being pasteurized or sterilized, may be stored at temperatures ranging from −20 to 35° C., and for periods of time ranging from 1 month to 3 years. Longer periods of storage are also possible, depending on the processing method, packaging method, and type of storage (e.g., freezing).

The present invention comprises products which are not auxiliary or intermediate, but used directly and immediately for a meal. The product in tubes serves as a main course, and salt, spices, seasonings, and sauces may be contained both in a particular product, as well as in additional layers located within the tube.

The offered product is novel in the fast food industry. It is very convenient, it can be taken along anywhere, it doesn't take up a lot of space, doesn't leave crumbs, it's not necessary to wash hands before or after consumption, and it does not require a plate, table, or utensils. It can be given to children to take to school, or taken along for work, on a journey, for a trip, and in a car. It can be eaten at any time in any place, without having fearing making a mess or getting dirty.

The product is both vacuum-sealed/air-tight and ready to eat directly as 100% ready-made product. The combination of flavors occurs immediately as the tube is squeezed, and the product requires no preparation or cooking. If desired, however, a user may heat the food product directly in the tube prior to consumption.

The added convenience of using a moldable/squeezable tube is that it is tolerant to damage; the tube will not break or crack if dropped. Further, the employment of a smaller nozzle for excretion and ingestion of the food product protects the consumer from dirtying clothes, furniture, and other clean surfaces. The tube also allows the consumer to easily dose/ration a product without supplementary tools or packages. The tube additionally reliably protects a product against environmental influence, capable of being hermetically resealed using the cap right after use, such that the product will not spoil for a long time, in some cases even after being opened.

Edible ingredients of the end-product are not mixed with each other to form a single, smooth, or homogenous fluid; however, because there is no boundary between the layers of multi-layered tubes, a slight diffusion occurs at the boundaries of layers. This slight diffusion allows for a light blending of flavors without destroying the separation, thus maintaining the freshness and particularities of the individual food products. Due to the paste-like state of the fillings, the ingredients of each food product are separated such that different components of varying proportions remain in separate layers within the tube and diffuse fully only at the outlet neck of the tube and out of the nozzle when the product is excreted for ingestion. Additionally, certain fillings comprise particles which are of a significant size (e.g., meat/fish filling, bread filling) and can withstand a chewing action if a user of the tube desires to chew the combination of food products. Thus, although the food is excreted from a tube, it offers an additional sensation of whole food (from larger pieces of bread) and a savory mouthfeel (from larger pieces of meat and/or fish and/or vegetables). At the same time, the smaller particles within the paste-like masses of food product fill any air gaps formed between larger particles, such that a vacuum is maintained within the tube and so that a consumer is provided with enough nutrients from a sufficient meal.

The product is also easy and convenient to use. The tube packaging allows for use of the product on the go in any situation (e.g., to and from work, during work/meeting) as well as during various daily activities such as eating while in a vehicle (either as driver or passenger), running, exercising, playing sports, hiking/camping. The packaging also offers the benefit of storing for varying periods of time without fear that the product will spoil or expire. The product is also a clean alternative to a messy plate of varying foods that might stain clothing or other property while being eaten. Furthermore, the product may be resealed easily and safely, and stored in order to ration an entire tubes-worth of food product into several meals or snacks.

The following examples describe different food products and proposed proportions to create palatable combinations of potentially known foods normally eaten by today's consumers.

### EXAMPLE 1

Processed or other fluid cheese is used. Proportions per 100 g of total product: 50-90 g of bread product, 10-50 g of cheese product. Optional addition: ketchup: 0-20 g. Mayonnaise: 0-20 g. Mustard: 0-20 g (and proportionally lowering the amount of relative bread product and cheese product components).

### EXAMPLE 2

Meat, sausage, chicken, liver, or fish paste; one or more types of meat or fish may be used, and vegetarian options are also available. Proportions per 100 g of total product 50-90 g of bread product, 10-50 g of meat, fish or combination meat/fish product. Salt, spices, vegetables, herbs, and seasonings may be placed in one or more separate layers (and proportionally lowering the amount of relative bread product and meat/fish product components).

### EXAMPLE 3

Meat, sausage, chicken, liver, or fish paste, or any other derivative of meat or fish paste are used (it is possible to use various types of meat or fish, as well as vegetarian ingredients). Processed or other fluid cheese is added. Several individual vertical layers are formed during injection. Proportions per 100 g of the product: 50-80 g of bread product, 10-30 g of meat, fish, combination meat/fish product, 10-30 g cheese product. Additional option to taste—ketchup: 0-20 g, mayonnaise: 0-20 g, mustard: 0-20 g (and proportionally lowering the amount of relative bread product and meat/fish product components).

The description of a preferred embodiment of the invention has been presented for purposes of illustration and description. It is not intended to be exhaustive or to limit the invention to the precise forms disclosed. Obviously, many modifications and variations will be apparent to practitioners skilled in this art. It is intended that the scope of the invention be defined by the following claims and their equivalents.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What is claimed is:

1. A food dispenser, comprising:
a squeezable tube, said tube comprising:
a top end with a narrowing outlet neck coupled to a nozzle,
a cap for sealing said top end, and
a sealed bottom end, and
one or more food products packaged into said squeezable tube, wherein at least one of said food products comprises freshly baked bread, wherein at least one of said food products comprises a paste-like mass, said one or more food products forming one or more layers within said tube,
said food dispenser being air tight before opening, and
said one or more food products being ready to eat.

2. The food dispenser according to claim 1, wherein said layers are vertical layers.

3. The food dispenser according to claim 2, further comprising a barrier between each said vertical layer, said barrier forming individual chambers within said tube, said barrier ending at said narrowing outlet neck.

4. The food dispenser according to claim 1, wherein two or more food products are packaged into said tube such that each of said two or more food products form alternating horizontal layers within said tube.

5. The food dispenser according to claim 4, wherein said alternating individual horizontal layers are uniform.

6. The food dispenser according to claim 4, wherein said alternating individual horizontal layers are non-uniform, such that no two combinatory excretions of food products caused by a squeezing of said tube are the same.

7. The food dispenser according to claim 1, wherein said food product comprising bread comprises particles up to 10 mm in diameter pass through said nozzle.

8. The food dispenser according to claim 1, wherein a first food product comprising a paste-like mass of bread forms a first vertical layer, and a second food product comprising a paste-like mass forms a second vertical layer, wherein a squeezing of said tube causes a combinatory excretion of said first and second food products through said nozzle.

9. The food dispenser according to claim 1, wherein a first food product comprising a paste-like mass of bread forms a first vertical layer, and a second food product comprising a homogenous fluid forms a second vertical layer, wherein a squeezing of said tube causes a combinatory excretion of said first and second food products through said nozzle.

10. The food dispenser according to either one of claim 9, wherein said first food product comprises bread particles up to 10 mm in diameter.

11. The food dispenser according to claim 1, wherein a first food product comprising a paste-like mass of bread forms a first vertical layer, a second food product comprising a homogenous fluid forms a second vertical layer, and a third food product comprising a paste-like mass forms a third vertical layer, wherein a squeezing of said tube causes a combinatory excretion of said first, second, and third food products through said nozzle.

12. The food dispenser according to claim 11, wherein said third food product comprises protein.

13. The food dispenser according to claim 12, wherein said first food product comprises bread particles up to 10 mm in diameter and said third food product comprises protein particles up to 10 mm in diameter.

14. The food dispenser according to claim 1, further comprising a removable membrane, said membrane sealing said nozzle prior to use.

15. A method of producing a food dispenser, comprising:
baking bread;
processing at least one food product to form a paste-like mass, said paste-like mass comprising chewable food particles up to 10 mm in diameter, the food product including freshly baked bread particles up to 10 mm in diameter;
packaging said at least one food product into one or more layers within a squeezable tube, and
sealing said squeezable tube at both ends.

16. The method of claim 15, wherein said packaging step is performed by an injecting machine.

17. The method of claim 16, wherein said injecting machine further comprises one or more harriers, said barriers facilitating a formation of said layers within said tube.

18. The method of claim 15, wherein said one or more layers are vertical layers.

19. The method of claim 15, wherein said one or more layers are horizontal layers.

20. The method of claim 15, wherein said one or more layers are vertical layers, said vertical layers further comprising horizontal layers.
